(19) United States
(12) Patent Application Publication
(10) Pub. No.: US 2008/0121850 A1
(43) Pub. Date: May 29, 2008

(54) COMPOSITION FOR PREPARING BUS-ELECTRODE OF PLASMA DISPLAY PANEL, AND PLASMA DISPLAY PANEL INCLUDING BUS-ELECTRODE PREPARED FROM SAME

(75) Inventors: JUNG-KEUN AHN, Yongin-si (KR); Chul-Hong Kim, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/942,096

(22) Filed: Nov. 19, 2007

(30) Foreign Application Priority Data
Nov. 27, 2006 (KR) 10-2006-0117636

(51) Int. Cl. H01B 1/08; H01B 1/20; B05D 5/12

(52) U.S. Cl. 252/520.3; 252/500; 252/521.2; 252/520.5; 427/77; 252/518.1

(57) ABSTRACT

A plasma display panel includes a bus electrode that is fabricated using a bus electrode forming composition that includes a black pigment, a conductive material, an organic binder, a photopolymerization initiator, and a cross-linking agent. The black pigment is present in an amount of 25 to 50 parts by weight based on 100 parts by weight of a conductive material.

### CROSS-REFERENCE TO RELATED APPLICATIONS

This application claims the benefit of Korean Application No. 2006-117636 filed on Nov. 27, 2006, in the Korean Intellectual Property Office the disclosure of which are incorporated herein by reference.

### BACKGROUND OF THE INVENTION

1. Field of the Invention

Aspects of the present invention relate to a bus electrode forming composition of a plasma display panel and a plasma display panel including a bus electrode prepared using the same. More particularly, aspects of the present invention relate to a bus electrode forming composition that avoids electrode pattern distortion due to mismatching between a black layer and a white layer of a bus electrode, decrease of film densification due to incomplete firing, electrode resistance increase, spot occurrence, and decrease of insulating properties of a dielectric layer.

2. Description of the Related Art

A plasma display panel (PDP) is a display device that forms an image by exciting phosphor with vacuum ultraviolet (VUV) rays generated by gas discharge in discharge cells. Since a PDP is capable of forming a large, high-resolution screen, PDPs have become popular as thin display devices.

A conventional PDP typically has a structure as follows. On a rear substrate, address electrodes are disposed in one direction and a dielectric layer is disposed on the address electrodes. Barrier ribs are formed on the dielectric layer in a stripe pattern. Red (R), green (G), and blue (B) phosphor layers are positioned on discharge cells between the barrier ribs.

On one surface of a front substrate facing the rear substrate, display electrodes are formed in a crossing direction with respect to the address electrodes. Each display electrode comprises a pair of transparent electrodes and a bus electrode. A dielectric layer and a protection layer are formed on the front substrate and cover the display electrodes.

Discharge cell are formed where the address electrodes of the rear substrate and the display electrodes of the front substrate cross each other.

With the above structure, address discharge is performed by applying an address voltage (Va) to a space between the address electrodes and the display electrodes. When a sustain voltage (Vs) is applied to a space between a pair of display electrodes, an excitation source generated from the sustain discharge excites a corresponding phosphor layer to thereby emit visible light through the front substrate so that image is displayed. The excitation source includes vacuum ultraviolet (VUV) rays.

Electrodes of a plasma display panel are formed by forming a metal thin film using a sputtering or deposition method, and then patterning the metal thin film in a predetermined shape. The patterning process may include a thin film patterning process or a thick film photolithograph patterning process. Thin film patterning includes coating a photo resist on a metal thin film, and then exposing, developing, and etching the same. Photolithograph patterning includes printing a photosensitive paste on a metal thin film, and then drying, exposing, and developing the same. Patterning may also be performed by a photolithographic depositing and patterning process. However, such a method requires extensive vacuum equipment and unit production is delayed. Thereby, the productivity deteriorates, the thickness of the produced layer varies, and defects occur when the film is formed on the substrate. On the other hand, this method provides a pattern with high precision.

In order to solve the above-described problems, a sheet process may be used in which the transcribing film including electrode materials is transcribed onto the substrate and the transcribed film is patterned and fired to provide an electrode. Such a process has merits in that it can be widely adapted to a large size panel and in that the size definition thereof is excellent. However, in this process, an edge-curl phenomenon, wherein edges of the electrodes are curled up after the firing process, typically occurs. The edge-curl phenomenon causes problems in that the resistance, sanding-resist, and withstand voltage characteristics of the plasma display panel are worsened.

A bus electrode of a conventional plasma display panel has a double-layered structure that includes a black layer and a white layer. As shown in FIGS. 2A-2D, a bus electrode pattern is conventionally formed by coating a composition for a black layer on a substrate on which a transparent electrode pattern is disposed followed by drying, and then coating a composition for a white layer followed by drying, exposing, developing, and firing. In particular, the conventional bus electrodes are manufactured by providing a substrate 11 having transparent electrodes 13a (FIG. 2A), coating and drying a composition for a black layer on the substrate to provide a photosensitive conductive layer 13c′ for a black layer (FIG. 2B), coating and drying a composition for a white layer and covering the conductive layer 13c′ to provide a photosensitive conductive layer 13d′ for a white layer (FIG. 2C), exposing, developing, and firing the same to provide an electrode pattern (FIG. 2D), and providing bus electrodes 13b having a double-layered structure of the black layer 13c and the white layer 13d formed on the transparent electrodes 13a (FIG. 2E).

However, a bus electrode having a double-layered structure is disadvantageous in that, since the exposing and developing processes of the white layer are affected by the coating thickness and the drying conditions of the black layer composition, the exposure sensitivity and developed degree of the white layer can vary and spots and stains can occur thereon. Further, in the subsequent firing process, since the black layer has a different organic material firing pattern and firing temperature from that of the white layer, the materials of the two layers are incompatible with each other so that the electrode pattern may be twisted and edge parts of the layers may be curled in the firing process. In addition, the film densification deteriorates due to the incomplete firing and thus, the electrode resistance is inappropriately increased. When the dielectric layer is formed on the bus electrode, air bubble traps may be formed on the upper surface or the edge part of the bus electrode dielectric layer to cause an insulating breakdown in the dielectric layer.

### SUMMARY OF THE INVENTION

According to an aspect of the present invention, there is provided a bus electrode forming composition that prevents an electrode pattern distortion due to mismatching between a black layer and a white layer of a bus electrode, decrease of a film densification due to incomplete firing, electrode resistance increase, spot occurrence, and decrease of insulating properties of a dielectric layer.

According to another aspect of the present invention, there is provided a plasma display panel that includes the bus electrode prepared from the composition.

According to another aspect of the present invention, a bus electrode forming composition includes a black pigment, a conductive material, an organic binder, a photopolymerization initiator, and a cross-linking agent.

According to another aspect of the present invention, the black pigment is present in an amount of 25 to 50 parts by weight based on 100 parts by weight of a conductive material.

According to another aspect of the present invention, a method of forming a bus electrode of a plasma display panel comprises forming a coating on a transparent electrode formed on a substrate, wherein the coating comprises both a black pigment and a conductive material intermixed.

According to another aspect of the present invention, a method of manufacturing a plasma display panel including: a transparent electrode on a substrate; forming a bus electrode by coating the bus electrode forming composition on the transparent electrode, followed by exposure, development, and firing; and providing a dielectric layer to cover the bus electrode.

According to yet another aspect of the present invention, a plasma display panel comprises a bus electrode, wherein the bus electrode comprises an integrated layer that includes both a black pigment and a conductive material.

According to yet another aspect of the present invention, the plasma display panel may include: a first substrate and a second substrate arranged opposite to each other; address electrodes and a dielectric layer covering the address electrodes disposed on the first substrate; display electrodes, including a transparent electrode and a bus electrode, and a dielectric layer covering the display electrodes disposed on the second substrate; barrier ribs disposed in a space between the first substrate and the second substrate to partition a plurality of discharge cells; and phosphor layers disposed on bottom surfaces of the discharge cells and sides of the barrier ribs.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A through 1D schematically show a manufacturing process of bus electrode fabrication using a bus electrode forming composition of a plasma display panel according to one embodiment.

FIGS. 2A through 2E schematically show a conventional manufacturing process of bus electrode fabrication of a plasma display panel.

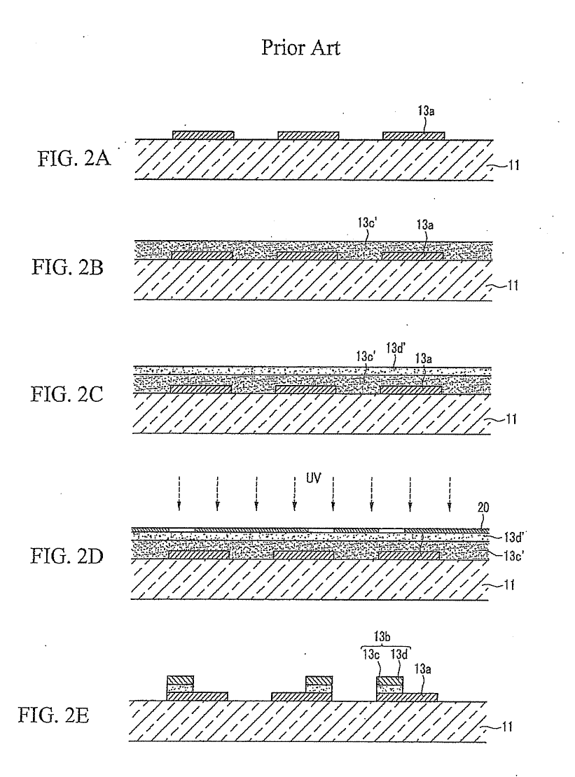

FIG. 3 is a partial exploded perspective view showing one embodiment of a plasma display panel according to aspects of the present invention.

FIG. 4 represents a photograph showing a bus electrode pattern of the plasma display panel according to Comparative Example 1.

FIG. 5 represents a photograph showing a bus electrode pattern of the plasma display panel according to Example 1.

FIG. 6 represents a photograph showing film densification of a bus electrode of the plasma display panel according to Comparative Example 1.

FIG. 7 represents a photograph showing film densification of a bus electrode of the plasma display panel according to Example 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

According to one embodiment of the present invention, a bus electrode has an integrated black and white layer that is formed by using a composition including a pigment component for blackening and a conductive material for conductivity. Thereby, providing such a bus electrode avoids electrode pattern distortion that can be caused by mismatching between a black layer and a white layer of a bus electrode, a decrease of a film densification due to incomplete firing, electrode resistance increase, the occurrence of spots in the bus electrode, and a decrease of insulating properties of a dielectric layer.

The bus electrode can reduce the reflective brightness of a front substrate resulting in contrast improvement of a plasma display panel. Furthermore, a simplified process for forming the bus electrode according to aspects of the present invention result in lower manufacturing costs.

According to one embodiment of the present invention, a bus electrode forming composition is provided that includes a) a black pigment, b) a conductive material, c) an organic binder, d) a photopolymerizable initiator, and e) a cross-linking agent. It is to be understood that although the bus electrode forming composition is referred to for convenience as having “a” black pigment, “a” conductive material, etc., this designation is not limiting and more that one type of material may be present for each of the components a) through e).

Hereinafter, the components of the bus electrode forming composition are described in more detail.

a) Black Pigment

Black pigments play a role of improving the display contrast of the plasma display panel.

As a non-limiting example, the black pigment may be a metal oxide that includes an element selected from the group consisting of Ru, Cr, Fe, Co, Mn, Cu, Ni, and combinations thereof. According to one embodiment, RuO₂, CuFe₂O₄, or a mixture thereof may be used, since these oxides have little color change during firing and have excellent blackening characteristics after firing.

Taking into account the leveling properties that may occur during painting, the specific surface area of the black pigment may range from 5 to 20 m²/g, for example. As non-limiting examples, the specific surface area may range from 5 to 10 m²/g, 10 to 15 m²/g, or 15 to 20 m²/g. According to a specific, non-limiting example, the specific surface area may range from 10 to 15 m²/g. When the specific surface area is less than 5 m²/g, the pigment particle may be overly enlarged, and thus it may be hard to provide the bus electrode with a high-definition pattern and may be impossible to provide a sufficient black fired film. On the other hand, when the specific surface area is more than 20 m²/g, the organic components included in the bus electrode forming composition may be difficult to evaporate, which can cause the firing characteristics to deteriorate, and thus cause a blister phenomenon to occur.

The black pigment may have an average particle diameter ranging from 0.05 to 5 μm, for example. According to non-limiting examples, the black pigment may have an average particle diameter ranging from 0.05 to 0.1 μm, 0.1 to 1 μm, 1 to 2 μm, 2 to 3 μm, 3 to 4 μm, or 4 to 5 μm. According to a specific, non-limiting example, the black pigment may have an average particle diameter of 1 to 2 μm. When the average particle diameter of the black pigment is less than 0.05 μm, the pigment particles may aggregate so that the diffusion thereof in the bus electrode forming composition is worse. On the other hand, when the average particle diameter of the black pigment is more than 5 μm, the ultraviolet (UV) transmittance for the exposure may be hindered so that the cross-sectional shape and precision of the electrode pattern may be worse.

The black pigment may be present in an amount of 25 to 50 parts by weight based on 100 parts by weight of the conductive material. As non-limiting examples, the amount of the black pigment may be 25 to 30 parts by weight, 30 to 35 parts by weight, 35 to 40 parts by weight, 40 to 45 parts by weight, or 45 to 50 parts by weight. According to a specific, non-limiting example, the amount of the black pigment may be 30 to 35 parts by weight. When the amount of the black pigment is less than 25 parts by weight, the degree of blackness may be worse and the outer light reflecting brightness may be increased. On the other hand, when the amount of black pigment is more than 50 parts by weight, the resistance may be remarkably increased and the brightness may be increased.

b) Conductive Material

The conductive material may be any metallic material that is used for electrodes and is not limited to any specific material.

Examples of the conductive material may include metal powders selected from the group consisting of silver (Ag), gold (Au), palladium (Pd), nickel (Ni), platinum (Pt), copper (Cu), chromium (Cr), cobalt (Co), aluminum (Al), tin (Sn), lead (Pb), zinc (Zn), iron (Fe), iridium (Ir), osmium (Os), rhodium (Rh), tungsten (W), molybdenum (Mo), and combinations thereof, for example. As non-limiting examples, silver (Ag), gold (Au), palladium (Pd), and so on are suitable since their conductivity is not reduced by oxidation during firing under atmosphere and their costs are relatively low.

The conductive material may be any suitable shape including a leaf shape, a spherical shape, or a flake shape, but is not limited thereto. For example, a spherical shape may be used when the photo characteristics and dispersion are considered. The conductive material may be a single shape or a mixture of more than two different shapes.

The conductive material may have an average particle diameter of 0.1 to 10 μm, for example. As non-limiting examples, the conductive material may have an average particle diameter of 0.1 to 2 μm, 2 to 4 μm, 4 to 6 μm, 6 to 8 μm, or 8 to 10 μm. According to a specific, non-limiting example, the conductive material may have an average particle diameter of 2 to 4 μm. When the conductive material has a particle size of less than 0.1 μm, the photo-transmission property of the bus electrode may be worse so that it may be difficult to provide a high definition electrode pattern. On the other hand, when the particle size is more than 10 μm, the straightness of the electrode pattern may be worse.

The conductive material may be added in amount of 40 wt % to 70 wt % based on the total weight of the bus electrode forming composition. As a specific, non-limiting example, the amount of conductive material may range from 55 to 65 wt %. When the amount of the conductive material is less than 40 wt %, the line width of the conductive layer may shrink when the bus electrode forming composition is fired. On the other hand, when the amount of the conductive material is more than 70 wt %, the printing property of the bus electrode forming composition may be imperfect and cross-linking may insufficiently performed due to low photo-transmission so that a desirable pattern may not be obtained.

c) Organic Binder

The organic binder provides excellent binding properties and may be a polymer easily removable by firing.

The organic binder may be any acryl-based resin, styrene resin, novolac resin, or polyester resin that is generally used in a photo resist composition. As a non-limiting example, the organic binder may be a polymer that is obtained by polymerizing at least one monomer selected from the group consisting of a) a monomer having a carboxyl group, b) a monomer having an OH group, and c) another monomer that can be copolymerized.

i) Monomer Having a Carboxyl Group Monomer

Non-limiting examples of the monomer having a carboxyl group include acrylic acid, methacrylic acid, maleic acid, fumaric acid, clotonic acid, itaconic acid, citraconic acid, mesaconic acid, cinamic acid, mono (2-(meth)acryloyloxyethyl) succinate, or ω-carboxyl-polycaprolactone mono(meth)acrylate.

ii) Monomer Having an OH Group

Non-limiting examples of the monomer having an OH group include 2-hydroxyethyl(meth)acrylate, 2-hydroxypropyl(meth)acrylate, 3-hydroxypropyl(meth)acrylate, a phenolic monomer having an OH group such as o-hydroxystyrene, m-hydroxystyrene, p-hydroxystyrene, and so on.

iii) Another Monomer that can be Copolymerized

Non-limiting examples of the other monomer that can be copolymerized include a (meth)acrylic acid ester such as methyl(meth)acrylate, ethyl(meth)acrylate, n-butyl(meth)acrylate, n-lauryl(meth)acrylate, benzyl(meth)acrylate, glycidyl(meth)acrylate, dicyclopentanyl(meth)acrylate, phosphate acrylate; an aromatic vinyl-based monomer such as styrene, α-methylstyrene, and so on; a conjugated diene such as butadiene, isoprene, and so on; a macromonomer (polymer) having a polymerizable unsaturated group such as a (meth)acryloyl group at one end of a polymer chain, such as polystyrene, poly(methyl(meth)acrylate), poly(ethyl(meth)acrylate), poly(benzyl(meth)acrylate), and so on.

The organic binder may have a weight average molecular weight (Mw) ranging from 5000 to 50,000 g/mol and an acid value ranging 20 to 100 mgKOH/g, so that the organic binder may have a suitable viscosity for coating the bus electrode forming composition onto a substrate to form a photosensitive conductive layer and so that the organic binder may be decomposed during a firing process. As non-limiting examples, the weight average molecular weight of the organic binder may range from 5,000 to 10,000 g/mol, 10,000 to 20,000 g/mol, 20,000 to 30,000 g/mol, 30,000 to 40,000 g/mol, or 40,000 to 50,000 g/mol. As non-limiting examples, the acid value of the organic binder may range from 20 to 40 mgKOH/g, 40 to 60 mgKOH/g, 60 to 80 mgKOH/g, or 80 to 100 mgKOH/g. When the molecular weight of the organic binder is less than 50,000 g/mol, the photosensitive conductive layer may not be closely attached during the development process. When the molecular weight of the organic binder is more than 50,000 g/mol, development failure may be induced. When the acid value is less than 20 mg KOH/g, is the organic binder may be hard to dissolve in an alkali aqueous solution, which may cause a failure of development. When the acid value is more than 100 mg KOH/g, the photosensitive conductive layer may not be closely attached during the development process, or exposed portions may be dissolved.

The organic binder may be used in an amount of 5 to 20 wt % based on the total weight of the composition for a bus electrode. As non-limiting examples, the organic binder may be used in an amount of 5 to 10 wt %, 10 to 15 wt %, or 15 to 20 wt %. When the amount of the organic binder is less than 5 wt %, the printing properties of the bus electrode forming composition may be poor, whereas when the amount of the organic binder is more than 20 wt %, development failure may be caused or a residue may remain around an electrode after firing.

d) Cross-Linking Agent

The cross-linking agent promotes curing of the bus electrode forming composition and improves the development of the composition. The cross-linking agent may be a compound that carries out a radical polymerization reaction when initiated by a photopolymerization initiator.

The cross-linking agent may include a multi-functional monomer that includes a (meth)acrylate. Non-limiting examples of the multi-functional monomer include ethylene glycol di(meth)acrylate, trimethylolpropane tri(meth)acrylate, tetramethylolpropane tetra(meth)acrylate, pentaerythrytol tetra(meth)acrylate, and so on; or a mono-, di-, tri- or higher ester that is obtained by a reaction of a polybasic acid and hydroxy alkyl(meth)acrylate. Non-limiting examples of the polybasic acid include phthalic acid, adipic acid, maleic acid, itaconic acid, succinic acid, and so on.

The cross-linking agent is added in an amount of 1 to 20 wt % based on the total weight of the bus electrode forming. As non-limiting examples, the cross-linking agent may be added in an amount of 1 to 5 wt %, 5 to 10 wt %, or 15 to 20 wt %. When the amount of the cross-linking agent is less than 1 wt %, the exposure sensitivity may be reduced during exposure for forming an electrode. When the amount of the cross-linking agent is more than 15 wt %, electrode patterns may not be clear due to a large linewidth and residues around the electrode patterns may occur.

e) Photopolymerization Initiator

The photopolymerization initiator may include any compound that generates radicals during an exposure process and that initiates a cross-linking reaction of the cross-linking agent. The cross-linking agent is not particularly limited.

As non-limiting examples, the photopolymerization initiator may include at least one selected from the group consisting of benzoin, benzoinester, acetophenone, aminoacetophenone, anthraquinone, thioxanthone, ketal, benzophenone, xanthone, phosphineoxide, peroxide, and combinations thereof. As more specific, non-limiting examples, the photopolymerization initiator may include at least one selected from the group consisting of benzoin, benzoinethylether, benzoinisopropylether, o-benzoylbenzoic acid methyl, 4,4-bis(dimethylamine)benzophenone, 2,2-diethoxyacetophenone, 2,2-dimethoxy-2-phenyl-2-phenylacetophenone, 2-methyl-[4-(methylthio)phenyl]-2-morpholinopropa-1-one, 2-benzyl-2-dimethylamino-1-(4-morpholinophenyl)-1-butanone, 2-methylanthraquinone, 2,4-diethylthioxanthone, acetophenone dimethylketal, xanthone, (2,6-dimethoxybenzoyl)-2,4,4-pentylphosphineoxide, and combinations thereof.

The photopolymerization initiator may be added in an amount of 0.1 to 8 wt % based on the total amount of the bus electrode forming composition. As non-limiting examples, the photopolymerization initiator may be added in an amount of 0.1 to 2 wt %, 2 to 4 wt %, 4 to 6 wt %, or 6 to 8 wt %. When the amount of the photopolymerization initiator is less than 0.1 wt %, the exposure sensitivity may be reduced. When the amount of the photopolymerization is more than 8 wt %, the linewidth of exposed parts may be too small or non-exposed parts may not be developed, and thereby, clear patterns may not be obtained.

The bus electrode forming composition may also include a glass frit.

The glass frit promotes adherence between the conductive material and the substrate during firing of the composition. The glass frit is softened during the firing process and then becomes attached to the substrate.

As non-limiting examples, the glass frit may be a non-lead glass selected from the group consisting of zinc oxide-silicon oxide-based (ZnO—SiO₂), zinc oxide-boron oxide-silicon oxide-based (ZnO—B₂O₃—SiO₂), zinc oxide-boron oxide-silicon oxide-aluminum oxide-based (ZnO—B₂O₃—SiO₂—Al₂O₃), bismuth oxide-silicon oxide-based (Bi₂O₃—SiO₂), bismuth oxide-boron oxide-silicon oxide-based (Bi₂O₃—B₂O₃—SiO₂), bismuth oxide-boron oxide-silicon oxide-aluminum oxide-based (Bi₂O₃—B₂O₃—SiO₂—Al₂O₃), bismuth oxide-zinc oxide-boron oxide-silicon oxide-based (Bi₂O₃—ZnO—B₂O₃—SiO₂) and bismuth oxide-zinc oxide-boron oxide-silicon oxide-aluminum oxide-based (Bi₂O₃—ZnO—B₂O₃—SiO₂—Al₂O₃). As a specific, non-limiting example, the glass frit may be a bismuth oxide-boron oxide-silicon oxide-based (Bi₂O₃—B₂O₃—SiO₂) glass frit.

The silicon oxide-based material may be included in the glass frit in an amount of 0.3 to 2 wt % of the glass frit. As non-limiting examples, the amount of the silicon oxide-based material may be 0.3 to 1 wt %, 1 to 1.5 wt %, or 1.5 to 2 wt %. When the silicon oxide-based material is included in an amount less than 0.3 wt %, the material fluidity may be too high, whereas when the amount of the silicon oxide-based material is more than 2 wt %, the material fluidity may be too low and crystallization may occur.

The shape of the glass frit is not specifically limited. As a non-limiting example, the glass frit may have a spherical shape. The average particle diameter of the glass frit may range from 0.1 to 5 μm. As non-limiting examples, the average particle diameter of the glass frit may be in the ranges of from 0.1 to 1 μm, 1 to 3 μm, or 3 to 5 μm. If the average particle diameter of the glass frit is outside the range of 0.1 to 5 μm, the surface of the bus electrode after the firing process may uneven and the straightness thereof may be inferior.

The glass frit may be included in an amount ranging from 1 to 10 wt % based on the total weight of the bus electrode forming composition. As non limiting examples, the amount of glass frit may range from 1 to 3 wt %, from 3 to 6 wt %, or from 6 to 10 wt %. When the amount of the glass frit is less than 1 wt %, the edge curl of the bus electrode may be increased, which increases the withstand voltage of the panel. On the other hand, when the amount of glass frit is more than 10 wt %, the discharge property of the bus electrode may be adversely affected.

The bus electrode forming composition may include one or more additives depending on the desired properties of the composition.

As non-limiting examples, the additive may be one or more of the following: a sensitizer that improves the sensitivity of the composition; a polymerization inhibitor, such as phosphoric acid, phosphoric acid ester, or a carboxylic acid-containing compound; an oxidation inhibitor, that improves the storage stability of the composition,; an ultraviolet ray absorber that improves the resolution of the formed bus electrode; an antifoaming agent such as a silicon-based or acryl-based compound that reduces pores in the composition; a dispersing agent that improves dispersion properties of the composition; a leveling agent, such as polyester modified dimethylpolysiloxane, polyhydroxycarboxylic acid amide, a silicon-based polyacrylate copolymer, or a fluoro-based paraffin compound, that improves the flatness of a printed layer formed with the composition; or a plasticizer that provides the thixotropy characteristics of the composition. The additive may be added in any suitable amount as needed.

The bus electrode forming composition including the above components may be prepared by dispersing the components in a suitable solvent.

The solvent may be any organic solvent generally used in this art. Non-limiting examples of the solvent include: ketones such as diethylketone, methylbutylketone, dipropylketone, cyclohexanone, and so on; alcohols such as n-pentenol, 4-methyl-2-pentenol, cyclohexanol, diacetonealcohol, and so on; ether-based alcohols such as ethylene glycol monomethylether, ethylene glycol monoethylether, ethylene glycol monobutylether, propylene glycol monomethylether, propylene glycol monoethylether, and so on; saturated aliphatic monocarboxylic acid alkyl esters such as n-butyl acetate and amyl acetate; lactic acid esters such as ethyl lactate, n-butyl lactate, and so on; and ether-based esters such as methylcellosolve acetate, ethylcellosolve acetate, propylene glycol monomethylether acetate, ethyl-3-ethoxypropinonate, 2,2,4-trimethyl-1,3-pentanediol mono (2-methylpropanoate), and so on. The solvent may be used singularly or in a mixture. As a specific, non-limiting example, the solvent may be 2,2,4-trimethyl-1,3-pentanediolmono (2-methylpropanoate).

The solvent may be used in an amount to obtain a composition having a suitable viscosity for forming a photosensitive conductive layer on an insulating substrate.

According to another embodiment of the present invention, a method of manufacturing a plasma display panel using the bus electrode forming composition is provided.

The plasma display panel is manufactured by a method that includes providing a transparent electrode on a substrate, coating the bus electrode forming composition on the transparent electrode followed by exposure, development, and firing to fabricate a bus electrode, and providing a dielectric layer to cover the bus electrode.

First, a transparent electrode is formed on a substrate.

The substrate may be a sheet-shaped insulating substrate, such as, for example, a substrate made of glass, silicon, alumina, and so on. As a specific, non-limiting example, a glass substrate may be used. The insulating substrate may be subject to pretreatment such as a reagent treatment with a silane coupling agent, a plasma treatment, or thin membrane formation using an ion plating method, a sputtering method, a vapor reaction method, a vacuum deposition method, etc.

The transparent electrode can be formed by any general method known in the art.

For example, the transparent electrode may be formed by spraying, chemical vapor deposition, sputtering, or photoetching. As non-limiting examples, the transparent electrode may be composed of indium tin oxide (ITO), SnO₂, ZnO, Sb doped SnO₂, or CdSnO.

On the transparent electrode, the bus electrode is formed using the bus electrode forming composition described above.

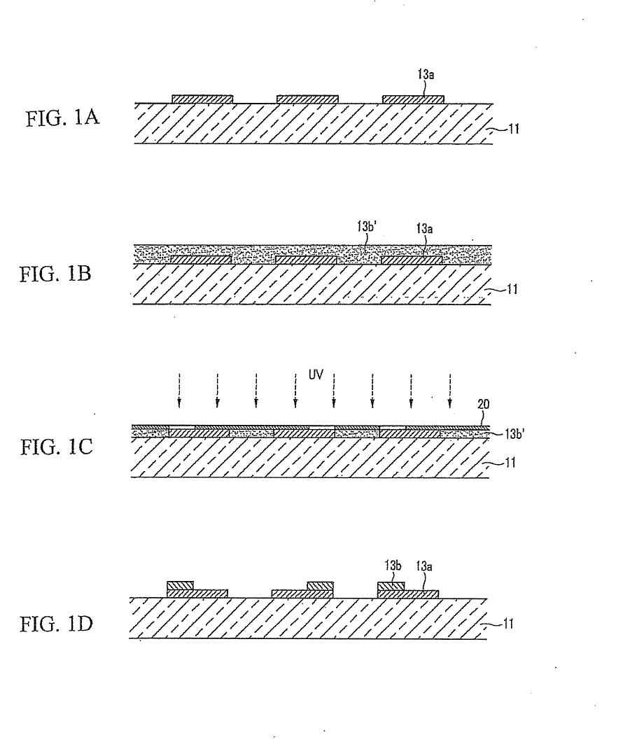

FIGS. 1A through 1D schematically show a process of fabricating a bus electrode of a plasma display panel according to an embodiment of the present invention using the bus electrode forming composition. Referring to FIG. 1A, a substrate 11 is provided that includes transparent electrodes 13a disposed thereon.

Referring to FIG. 1B, the bus electrode forming composition is coated to cover the transparent electrodes 13a on the substrate 11 and the coated composition is dried to form a photosensitive conductive layer 13b′.

The bus electrode forming composition is prepared by dispersing the black pigment, the conductive material, the organic binder, the photopolymerizable initiator, the cross-linking agent, and the photopolymerization initiator in the solvent as described above. Alternatively, the bus electrode forming composition may be prepared as follows: the organic binder and the photopolymerization initiator are mixed, then the black pigment, the conductive material, and the cross-linking agent are added, and the mixture is dispersed in the solvent.

The bus electrode forming composition may be controlled to have sufficient fluidity for coating by selecting the identity and relative amount of the components of the composition. As a non-limiting example, the bus electrode forming composition may be controlled to have a viscosity of 1,000 to 100,000 cps. As specific, non-limiting examples, the composition may have a viscosity of 1,000 to 10,000 cps, 10,000 to 30,000 cps, 30,000 to 60,000 cps, or 60,000 to 100,000 cps. When the viscosity of the bus electrode forming composition is less than 1000 cps, the fluidity thereof may be overly increased. On the other hand, when the viscosity is more than 100,000 cps, it may be difficult to obtain a uniform coating.

The dispersion of the components of the bus electrode forming composition may be performed by an apparatus such as, for example, a roll kneader, a mixer, a homo mixer, a ball mixer, a bead mill, and so on.

The provided bus electrode forming composition may be coated to cover the transparent electrodes 13a by any conventional wet coating process. Particularly, as non-limiting examples, the wet coating process may include screen printing, or coating using a roll coater, a blade coater, a slit coater, a curtain coater, or a wire coater.

The drying process for the coated bus electrode forming composition to form the photosensitive conductive layer may be selected depending upon the solvent used in the composition. As a non-limiting example, the drying may be performed at a temperature ranging from 50 to 150° C. As specific, non-limiting embodiments, the drying temperature may range from 50 to 100° C. or from 100 to 150° C.

The photosensitive conductive layer 13b′ prepared from the process described above may have a thickness of 5 to 30 μm taking into consideration the thickness required in the bus electrode for the plasma display panel. As non-limiting examples, it has a thickness of 5 to 10 μm, 10 to 20 μm, or 20 to 30 μm.

Subsequently, as shown in FIG. 1C, the surface of the photosensitive conductive layer 13b′ is exposed to light, and developed and fired.

In the exposure process, the latent image of a predetermined pattern is formed on the photosensitive conductive layer 13b′ by masking the surface of the photosensitive conductive layer 13b′ with a photo mask 20 having a predetermined pattern, and selectively irradiating (exposing) the same with radioactive rays.

The exposure may be performed with at least one radioactive ray selected from the group consisting of visible light, ultraviolet (UV), far ultraviolet (UV), electron beam, and X-ray by using a common exposure apparatus. As a specific, non-limiting example, ultraviolet (UV) exposure may be performed using a high pressure mercury lamp having 400 mJ/cm² to 500 mJ/cm².

Then, the exposed photosensitive conductive layer 13b′ is developed with an alkaline developing solution and the non-exposed photosensitive conductive layer portion is removed to provide an electrode pattern on the insulation substrate.

The development solution may be a base aqueous solution. As non-limiting examples, the base may be selected from the group consisting of an inorganic alkali compound such as, for example, lithium hydroxide, sodium hydroxide, potassium hydroxide, sodium hydrogen phosphate, diammonium hydrogen phosphate, dipotassium hydrogen phosphate, disodium hydrogen phosphate, dihydrogen ammonium phosphate, dihydrogen potassium phosphate, dihydrogen sodium phosphate, lithium silicate, sodium silicate, potassium silicate, lithium carbonate, sodium carbonate, potassium carbonate, lithium borate, sodium borate, potassium borate, ammonia, and so on; and an organic alkali compound such as, for example, tetramethyl ammonium hydroxide, trimethyl hydroxyl ethyl ammonium hydroxide, monomethylamine, dimethylamine, trimethylamine, monoethylamine, diethylamine, triethylamine, monoisopropylamine, diisopropylamine, ethanolamine, and so on.

The developing process may be performed under conventional developing treatment conditions. Developing treatment conditions that can be varied may include the identity and relative amounts of components of the developing composition, the concentration of the developing solution, the developing duration, the developing temperature, the particular developing process, such as dipping, agitating, showering, spraying, or paddling, as non-limiting examples, and the developing device.

After the developing process, a washing process may be performed to remove materials that may remain on the side surface of the electrode pattern and on the exposed surface of the insulation substrate.

The bus electrode pattern formed on the transparent electrodes 13a is fired to remove organic materials other than the conductive materials and the black pigment in the bus electrode pattern.

As a non-limiting example, the firing may be performed at between 400° C. and 600° C. As specific non-limiting examples, the firing may be performed at between 400° C. and 500° C. or between 500° C. and 600° C. If the firing temperature is outside the above range, pores may be formed in the bus electrodes. Particularly, when the temperature is less than 400° C., inside pores may remain or the firing densification may not be chieved. On the other hand, when the firing termperature is more than 600° C., the membrane density may be insufficient due to the over firing.

As a non-limiting example, the firing process may be performed under an atmosphere of air, oxygen, nitrogen, argon, or a mixed gas thereof.

As shown in FIG. 1D, bus electrodes 13b having a predetermined pattern are formed by the exposing, developing, and firing processes described above.

The method for preparing bus electrodes according to the embodiment can provide a single-layered structure incorporating the black layer and the white layer. Therefore, the manufacturing process is simplified, the process duration is shortened, and imperfections are decreased, and bus electrodes with a uniform electrode pattern may be formed.

A dielectric layer forming composition may be coated and dried on the substrate and disposed to cover the bus electrodes so as to provide a dielectric layer.

The dielectric layer forming composition may include any composition commonly used for forming a dielectric layer. As a specific, non-limiting example, the dielectric layer forming composition may include a glass powder. The glass powder may include at least one selected from the group consisting of ZnO, B₂O₃, Al₂O₃, SiO₂, SnO, P₂O₅, Sb₂O₃, and Bi₂O₃.

Subsequently, a protective layer may be formed to cover the dielectric layer.

The protective layer may be at least one layer including one or more selected from the group consisting of fluoride, oxide, and combinations thereof. Particularly, as non-limiting examples, the protective layer may include at least one selected from the group consisting of fluoride such as MgF₂, CaF₂, or LiF; and oxide such as MgO, Al₂O₃, ZnO, CaO, SrO, SiO₂, or La₂O₃.

The protection layer forming method is not specifically limited. The protective layer may be formed by a thick layer printing method using a paste, or by a plasma deposition method. For example, a plasma deposition method may be used to provide a protective layer that is relatively strong against sputtering based on ion impact and that can reduce the discharge initiating voltage and the discharge sustain voltage by the emission of secondary electrons.

As non-limiting examples, the plasma deposition method may be magnetron sputtering, electron beam deposition, Ion Beam Assisted Deposition (IBAD), Chemical Vapor Deposition (CVD), or ion plating.

Next, address electrodes, a dielectric layer, barrier ribs, and phosphor layers are sequentially formed on another substrate. The two substrates are positioned to face each other, followed by exhausting the air therebetween, and sealing the two substrates together to fabricate a plasma display panel.

According to one embodiment of the present invention, the method for fabricating the plasma display panel using the bus electrodes forming composition can provide single-layered bus electrodes in which the black layer and the white layer are incorporated, instead of conventional double-layered bus electrodes having separate the black and white layers. Thereby, this method can prevent the appearance of spots due to the difference of exposure sensitivity and developing degree of separate black and white layers, the distortion of the electrode pattern due to the difference of the burn out profile and the firing temperature of separate black and white layers, the decrease of film densification due to incomplete firing, and the increase of electrode resistance. It can also prevent the insulation of the dielectric layer from the breakdown by generating the trap of the pores on the upper or the edge of the electrodes when the dielectric layer is formed on the electrodes.

According to another embodiment of the present invention, a plasma display panel that includes the bus electrodes fabricated using the bus electrode forming composition is provided.

The plasma display panel according to aspects of the present invention includes: a first substrate and a second substrate arranged opposite to each other; address electrodes and a dielectric layer covering the address electrodes disposed on the first substrate; display electrodes including a transparent electrode and a bus electrode and a dielectric layer covering the display electrodes on the second substrate; barrier ribs disposed in a space between the first substrate and the second substrate to partition a plurality of discharge cells; and phosphor layers disposed on bottom surfaces of the discharge cells and sides of the barrier ribs. The bus electrode is fabricated using the above-described bus electrode forming composition.

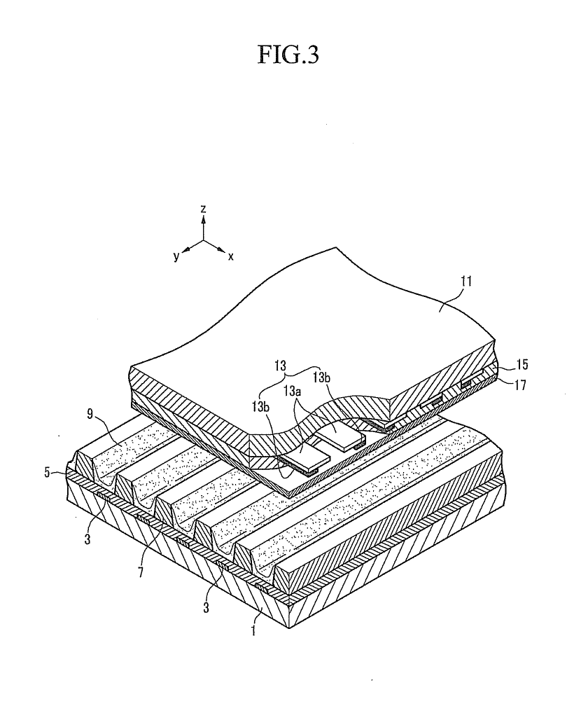

FIG. 3 is a partial exploded perspective view showing a plasma display panel in accordance with an embodiment of the present invention. However, aspects of the present invention are not limited to the structure illustrated in FIG. 3.

Referring to FIG. 3, the plasma display panel includes a first substrate 1, a plurality of address electrodes 3 disposed in one direction (a Y direction in the drawing) on the first substrate 1, and a dielectric layer 5 disposed on the entire surface of the first substrate 1 covering the address electrodes 3. Barrier ribs 7 are formed on the dielectric layer 5 and between the address electrodes 3. Red (R), green (G), and blue (B) phosphor layers 9 are disposed between the barrier ribs 7.

Display electrodes 13, each including a pair of a transparent electrode 13a and a bus electrode 13b, are disposed in a direction crossing the address electrodes 3 (an X direction in the drawing) on the side of a second substrate 11 facing the first substrate 1. Also, a transparent dielectric layer 15 and a passivation layer 17 are disposed on the entire surface of the second substrate 11 to cover the display electrodes 13. Thereby, discharge cells are formed at positions where the address electrodes 3 cross the display electrodes 13.

The bus electrodes 13b of the second substrate 11 are fabricated using the bus electrode forming composition as described above.

With the above described structure, an address discharge is performed by applying an address voltage (Va) to a space between the address electrodes 3 and any one display electrode 13. When a sustained voltage (Vs) is applied to a space between a pair of display electrodes 13, vacuum ultraviolet rays generated from the sustained discharge excite a corresponding phosphor layer 9 to thereby emit visible light through the second substrate 11.

The bus electrodes fabricated using the bus electrode forming composition can be formed in a uniform electrode pattern and include the black pigment to implement an integrated single-layered electrode structure. Thereby, the reflective brightness of the second substrate can be decreased, resulting in contrast improvement.

The following examples illustrate the present invention in more detail. However, it is understood that the present invention is not limited by these examples.

### COMPARATIVE EXAMPLE 1

Methylmethacrylate and methacrylic acid were mixed in a mole ratio of 0.76:0.27 in a solvent of dipropylene glycol mono methyl ether. Then a catalyst of azobisisobutyinitrile was added and the mixture was agitated at 80° C. for 6 hours under a nitrogen atmosphere to provide a resin solution. The provided resin solution was cooled down, a polymerization inhibitor of methylhydroquinine and a catalyst of tetrabutylphosphonium bromide were added thereto, and glycidylmethacrylate was added and the mixture was subjected to the addition reaction at 100° C. for 16 hours at an addition mole ratio of 0.12 mol to 1 mole of carboxyl group of the resin to provide an organic binder (weight average molecular weight: 10,000, acid value: 59 mgKOH/g). 100 parts by weight of the obtained organic binder, 50 parts by weight of pentaerythrytoltriacrylate, 5 parts by weight of 2-benzyl-2-dimethylamino-1-(4-morpholinophenyl)butane-1-one, 80 parts by weight of dipropylene glycol mono methylether, 450 parts by weight of silver powder, 22 parts by weight of a glass frit (PbO 60%, B₂O₃ 20%, SiO₂ 15%, Al₂O₃ 5%, glass transforming point 445° C., average particle diameter 1.6 μm), and 1 parts by weight of phosphoric acid ester were mixed to provide a white layer forming composition.

Additionally, methylmethacrylate and methacrylic acid were combined at a mole ratio of 0.87:0.13 and dissolved in a solvent of dipropylene glycol mono methyl ether. A catalyst of azobisisobutyinitrile was dissolved in the solution and the solution was agitated at 80° C. for 6 hours under a nitrogen atmosphere to provide an organic binder (weight average molecular weight: 10,000, acid value: 74 mgKOH/g). 100 parts by weight of the provided organic binder, 50 parts by weight of pentaerythrytoltriacrylate, 5 parts by weight of 2-benzyl-2-dimethylamino-1-(4-morpholinophenyl)butane-1-one, 80 parts by weight of dipropylene glycol mono methylether, and 20 parts by weight of ruthenium oxide (RuO₂, specific surface area 50.5 m²/g) were mixed to provide a black layer forming composition.

An ITO-containing transparent electrode was formed on a glass substrate, and then the black layer forming composition was coated on the front surface thereof using a 300 mesh polyester screen and the coated black layer was dried at 90° C. for 20 minutes in a dry furnace with circulating hot air to provide a film having a good contact dryness. Subsequently, the white layer forming composition was coated on the front surface thereof using a 200 mesh polyester screen and dried at 90° C. for 20 minutes in a dry furnace with circulating hot air to provide a double-layered film having good dryness to touch.

The front surface of the film was exposed by a metal halide lamp at an intensity of radiation of 500 mJ/cm² and developed using a 1 wt % Na₂CO₃ aqueous solution having a solution temperature of 30° C. and washed with water. The developed surface was heated to 550° C. at 5° C./min under an air atmosphere and fired for 30 minutes to provide a bus electrode.

A dielectric layer forming composition including 28.4 wt % of SiO₂, 69.8 wt % of ZnO, and 1.8 w % of B₂O₃ was further coated on the bus electrode, dried, and fired to provide a dielectric layer.

A second substrate formed with address electrodes, barrier ribs, and a phosphor layer was sealed with the first substrate formed with the display electrodes, and a dielectric layer. Then, air was exhausted from the discharge space formed between the first and second substrate and a discharge gas was injected at 400 Torr. The first substrate and the second substrate were sealed together to provide a plasma display panel (PDP).

### EXAMPLE 1

Methylmethacrylate and methacrylic acid were combined at a molar ratio of 0.87:0.13 and dissolved into a solvent of dipropylene glycol mono methyl ether. A catalyst of azobisisobutyinitrile was added and the mixture was agitated at 80° C. for 6 hours under a nitrogen atmosphere to provide an organic binder (weight average molecular weight: 10,000, acid value: 74 mgKOH/g). 100 parts by weight of the provided organic binder, 50 parts by weight of pentaerythrytoltriacrylate, 5 parts by weight of 2-benzyl-2-dimethylamino-1-(4-morpholinophenyl)butane-1-one, 80 parts by weight of dipropylene glycol mono methylether, 25 parts by weight of ruthenium oxide (RuO₂, specific surface area 20 m²/g, average particle diameter 5 μm), 100 parts by weight of silver powder (average particle diameter: 2 μm), 22 parts by weight of a glass frit (PbO 60%, B₂O₃ 20%, SiO₂ 15%, Al₂O₃ 5%, glass transforming point 445° C., average a particle diameter 1.6 μm), and 1 part by weight of phosphoric acid ester were mixed to provide a bus electrode forming composition.

An ITO-containing transparent electrode was formed on a glass substrate, and then the bus electrode forming composition was coated on the front surface thereof using a 200 mesh polyester screen and dried at 90° C. for 20 minutes in a dry furnace with circulating hot air to provide a conductive film having a good contact dryness.

The front surface of the film was exposed by the light of a metal halide lamp at an intensity of radiation of 500 mJ/cm² and developed using a 1 wt % Na₂CO₃ aqueous solution having a solution temperature of 30° C. and washed with water. The developed surface was heated to 550° C. at 5° C./min under an air atmosphere and fired for 30 minutes to provide a bus electrode.

A dielectric layer forming composition including 28.4 wt % of SiO₂, 69.8 wt % of ZnO, and 1.8 w % of B₂O₃ was coated on the bus electrode, dried, and fired to provide a dielectric layer.

A second substrate formed with address electrodes, barrier ribs, and a phosphor layer was sealed with the first substrate formed with the display electrodes, and a dielectric layer. Then, air was exhausted from the discharge space between the first and second substrate and a discharge gas was injected at 400 Torr. The first and second substrates were sealed to provide a plasma display panel (PDP).

### EXAMPLES 2 TO 25

Plasma display panels were fabricated in the same procedure as in Example 1 except that the materials and the contents of the black pigment and the conductive material were varied as shown in the following Table 1.

TABLE 1

| | Black pigment | | | | | | |
|---|---|---|---|---|---|---|---|
| | | specific | | | Conductive material | | |
| | | surface | Particle | Content | | Particle | Content |
| | | area | size | (parts by | | size | (parts by |
| | Material | (m²/g) | (μm) | weight) | Material | (μm) | weight) |
| Ex. 2 | RuO₂ | 5 | 2 | 30 | Ag | 2 | 100 |
| Ex. 3 | RuO₂ | 20 | 2 | 30 | Ag | 2 | 100 |
| Ex. 4 | RuO₂ | 15 | 0.05 | 30 | Ag | 2 | 100 |
| Ex. 5 | RuO₂ | 15 | 5 | 30 | Ag | 2 | 100 |
| Ex. 6 | RuO₂ | 15 | 2 | 25 | Ag | 2 | 100 |
| Ex. 7 | RuO₂ | 15 | 2 | 50 | Ag | 2 | 100 |
| Ex. 8 | RuO₂ | 15 | 2 | 30 | Ag | 0.1 | 100 |
| Ex. 9 | RuO₂ | 15 | 2 | 30 | Ag | 10 | 100 |
| Ex. 10 | CuFe₂O₄ | 10 | 0.1 | 35 | Ag—Ni | 4 | 100 |
| Ex. 11 | CuO—Fe₂O₃—Mn₂O₃ | 15 | 3 | 40 | Ag—Cu | 6 | 100 |
| Ex. 12 | NiFe₂O₄ | 20 | 4 | 45 | Ag—Al | 8 | 100 |
| Ex. 13 | Cu(Cr, Fe)₂O₄ | 15 | 2 | 30 | Au | 10 | 100 |
| Ex. 14 | RuO₂—CuFe₂O₄ | 15 | 2 | 35 | Pd | 0.5 | 100 |
| Ex. 15 | Cr oxide | 15 | 2 | 35 | Pt | 1 | 100 |
| Ex. 16 | Fe oxide | 15 | 2 | 35 | Co—Cr | 3 | 100 |
| Ex. 17 | Co oxide | 15 | 2 | 35 | Sn | 5 | 100 |
| Ex. 18 | Mn oxide | 15 | 2 | 35 | Pb | 7 | 100 |
| Ex. 19 | Cu oxide | 15 | 2 | 35 | Zn | 9 | 100 |
| Ex. 20 | Ni oxide | 15 | 2 | 35 | Fe | 3 | 100 |
| Ex. 21 | Metal | 15 | 2 | 35 | Ir | 5 | 100 |
| | composite | | | | | | |
| | oxide | | | | | | |
| Ex. 22 | Metal | 15 | 2 | 35 | Os | 7 | 100 |
| | composite | | | | | | |
| | oxide | | | | | | |
| Ex. 23 | Metal | 15 | 2 | 35 | Rh | 9 | 100 |
| | composite | | | | | | |
| | oxide | | | | | | |
| Ex. 24 | Metal | 15 | 2 | 35 | W | 10 | 100 |
| | composite | | | | | | |
| | oxide | | | | | | |
| Ex. 25 | Metal | 15 | 2 | 35 | Mo | 10 | 100 |
| | composite | | | | | | |
| | oxide | | | | | | |

For the plasma display panel according to Example 1, the thicknesses and widths of the patterned bus electrodes were monitored before and after firing by an optical auto measuring apparatus (manufactured by Sokkia Co., Ltd.). The results are shown in the following Table 2.

TABLE 2

| | |
|---|---|
| Linewidth | Thickness |
| variation | variation |

| | Before | After | Before | After |
|---|---|---|---|---|
| | firing | firing | firing | firing |
| Average length (μm) | 90.41 | 67.19 | 8.17 | 4 |
| Maximum value (μm) | 92.89 | 70.48 | 8.4 | 4.2 |
| Minimum value (μm) | 88.95 | 61.29 | 7.8 | 3.8 |
| Variation | 3.94 | 9.19 | 0.6 | 0.4 |

As shown in Table 2, it was confirmed that the bus electrodes in the plasma display panel according to Example 1 were deformed very little during the firing process. From these results, it can be seen that the bus electrode using the bus electrode forming composition according to aspects of the present invention showed an improved electrode pattern even though the conductive material was used in a relatively low amount. The component composition and the amount thereof were optimized compared to a conventional electrode composition.

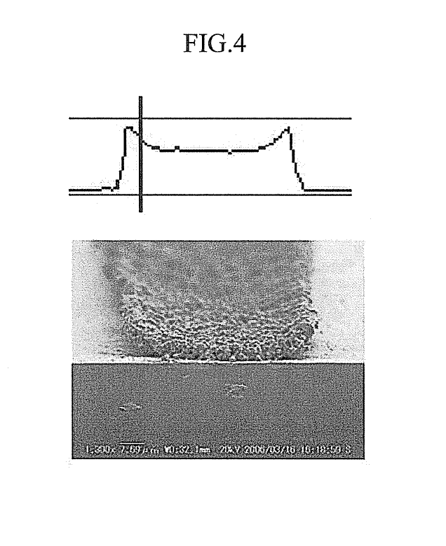

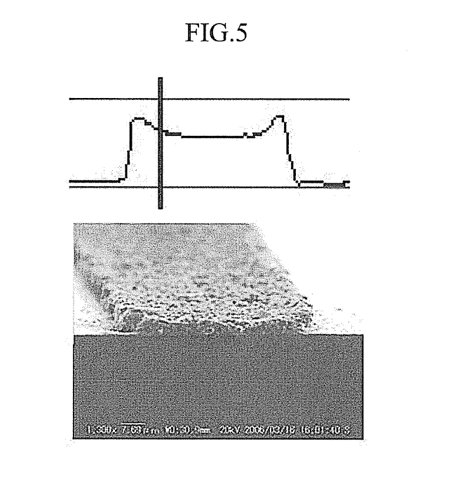

The patterns of bus electrodes of the plasma display panels according to Example 1 and Comparative Example 1 were measured and scanned by the optical auto measure apparatus (manufactured by SOKIA). The results are shown in FIGS. 4 and 5.

FIG. 4 represents a photograph showing a bus electrode pattern of the plasma display panel according to Comparative Example 1, and FIG. 5 represents a photograph showing a bus electrode pattern of the plasma display panel according to Example 1.

As can be seen by comparing FIGS. 4 and 5, a remarkable edge curl occurred in the bus electrode of the plasma display panel according to Comparative Example 1, but an edge curl or other irregular change or distortion of the bus electrode according to Example 1 was much less.

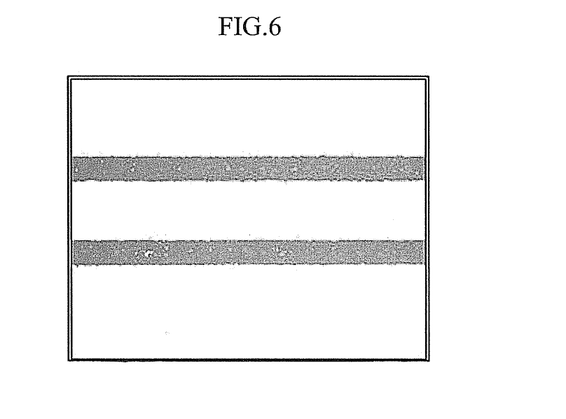

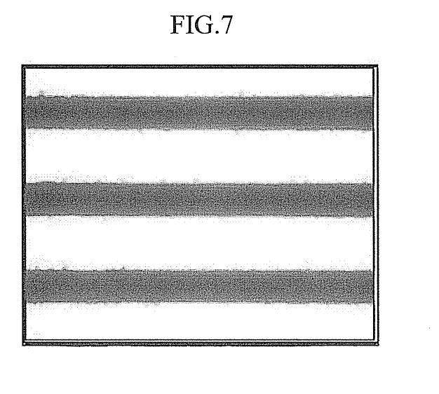

Bus electrodes of the plasma display panels according to Example 1 and Comparative Example 1 were measured by an optical auto measuring apparatus (manufactured by Sokkia) and an optical microscope (manufactured by Olympus) to determine the film densification. The results are shown in FIGS. 6 and 7.

FIG. 6 represents a photograph showing a film densification of a bus electrode of the plasma display panel according to Comparative Example 1, and FIG. 7 respresents a photograph showing film densification of a bus electrode of the plasma display panel according to Example 1.

As can be seen in FIGS. 6 and 7, the bus electrode of the plasma display panel according to Comparative Example 1 has a lot of white portions, but the bus electrode according to Example 1 has a dark back color and has few white portions in the black strip.

From these results, it can be confirmed that the bus electrodes of the plasma display panel according to Example 1 have a more excellent film densification.

For plasma display panels of Example 1 and Comparative Example 1, the black degree and the conductivity were measured. The results are shown in the following Table 3.

The black degree was measured by a spectrophotometric colorimeter (manufactured by Minolta camera, CM-2600d) to determine the L*a*b color matrix system value according to JIS-Z-8729 (“Specification of Colour of Materials according to the CIE 1976 (L*a*b*) Space and the CIE 1976 (L*a*b*) Space”, JIS Z 8729, February 1980”). The L* value for lightness was set for the black degree.

In the L*a*b color matrix system, the L* channel represents the lightness indicating degree from bright to dark, and the black degree is increased as the L* value is lowered. Furthermore, the a*channel represents the relationship between green and red colors. A green color is indicated as the a* value becomes negative and a red color is indicated as the a* value becomes positive. The b* channel represents the relationship between blue and yellow colors. A blue color is indicated as the b* value becomes negative and a yellow color is indicated as the value becomes positive.

The conductivity was determined by measuring the resistance of a 50 inch bus electrode.

The black portion ratio of the plasma display panel was 14%.

TABLE 3

| | L* | b* | Line resistance |
|---|---|---|---|
| Comparative | 60.72 | −3.94 | 89 Ω |
| Example 1 | | | |
| Example 1 | 62.09 | −4.12 | 103 Ω |

As shown in Table 3, the black degree of the plasma display panel according to Example 1 was remarkably improved in comparison to that of Comparative Example 1 and its line resistance is equivalent to that of Comparative Example 1. In general, in the case that the black degree increases, line resistance increases. However, when the line resistance is excessively increased to 125Ω or more, the brightness and brightness balance of a plasma display panel decrease and the sustaining voltage increases. Nevertheless, the plasma display panel including the electrode fabricated using the composition according to aspects of the present invention showed an improved black degree and line resistance.

Plasma display panels according to Examples 2 to 25 were measured to determine the black degree and conductivity of the bus electrode. The results (not shown) indicated similar levels of black degree and conductivity to those of the bus electrode of the plasma display panel according to Example 1.

According to aspects of the present invention, a bus electrode is formed in a uniform pattern using a bus electrode forming composition. Forming the bus electrode using the bus electrode forming composition prevents electrode pattern distortion due to mismatching between a black layer and a white layer of the bus electrode, decrease of a film densification due to incomplete firing, electrode resistance increase, spot occurrence, and decrease of insulating properties of a dielectric layer. The bus electrode can reduce the reflective brightness of a front substrate resulting in contrast improvement of a plasma display panel. Furthermore, working process reductions keep manufacturing costs low.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A bus electrode forming composition for a bus electrode of a plasma display panel comprising:
a black pigment;
a conductive material;
an organic binder;
a photopolymerization initiator; and
a cross-linking agent,
wherein the black pigment is present in an amount of 25 to 50 parts by weight based on 100 parts by weight of the conductive material.

2. The composition of claim 1, wherein the black pigment is present in an amount of 30 to 35 parts by weight based on 100 parts by weight of the conductive material.

3. The composition of claim 1, wherein the black pigment is at least one metal oxide containing an element selected from the group consisting of Ru, Cr, Fe, Co, Mn, Cu, and combinations thereof.

4. The composition of claim 1, wherein the black pigment has a specific surface area of 5 to 20 m²/g.

5. The composition of claim 1, wherein the black pigment has an average particle diameter of 0.05 to 5 μm.

6. The composition of claim 1, wherein the conductive material is at least one selected from the group consisting of Ag, Au, Pd, Ni, Pt, Cu, Cr, Al, Sn, Pb, Zn, Fe, Pt, Ir, Os, Pd, Rh, W, Mo, and combinations thereof.

7. The composition of claim 1, wherein the conductive material has an average particle diameter of 0.1 to 10 μm.

8. The composition of claim 1, wherein the conductive material is present in an amount of 40 to 70 wt % based on the total weight of the composition.

9. The composition of claim 1, wherein the organic binder is at least one selected from the group consisting of an acryl-based resin, a styrene resin, a novolac resin, a polyester resin, and combinations thereof.

10. The composition of claim 1, wherein the organic binder is present in an amount of 5 to 20 wt % based on total weight of the composition.

11. The composition of claim 1, wherein the cross-linking agent is at least one selected from the group consisting of an acrylate; a methacrylate; a mono-, di-, tri- or higher ester that is obtained by a reaction of a polybasic acid and hydroxy alkyl(meth)acrylate; and combinations thereof.

12. The composition of claim 1, wherein the cross-linking agent is present in an amount of 1 to 15 wt % based on total weight of the composition.

13. The composition of claim 1, wherein the photopolymerization initiator is at least one selected from the group consisting of benzoin; benzoinester; acetophenone; aminoacetophenone; anthraquinone; thioxanthone; ketal; benzophenone; xanthone; phosphineoxide; peroxide, and combinations thereof.

14. The composition of claim 1, wherein the photopolymerization initiator is present in an amount of 0.1 to 8 wt % based on total weight of the composition.

15. The composition of claim 1, wherein the composition further comprises a glass frit.

16. The composition of claim 15, wherein the glass frit has a softening temperature of 400 to 600° C.

17. The composition of claim 15, wherein the glass frit comprises at least one glass selected from the group consisting of zinc oxide-silicon oxide-based, zinc oxide-boron oxide-silicon oxide-based, zinc oxide-boron oxide-silicon oxide-aluminum oxide-based, bismuth oxide-silicon oxide-based, bismuth oxide-boron oxide-silicon oxide-based, bismuth oxide-boron oxide-silicon oxide-aluminum oxide-based, bismuth oxide-zinc oxide-boron oxide-silicon oxide-based and bismuth oxide-zinc oxide-boron oxide-silicon oxide-aluminum oxide-based, and combinations thereof.

18. The composition of claim 15, wherein the glass frit is present in an amount of 1 to 10 wt % based on total weight of the composition.

19. The composition of claim 15, wherein the silicon oxide is present in an amount of 0.3 to 2 wt % based on the total weight of the glass frit.

20. The composition of claim 15, wherein the glass frit has an average particle diameter of 0.1 to 5 μm.

21. The composition of claim 1, wherein the composition further comprises at least one additive selected from the group consisting of a photosensitizer, a polymerization inhibitor, an antioxidant, an ultraviolet (UV) absorber, an antifoaming agent, a dispersing agent, a leveling agent, a plasticizer, and combinations thereof.

22. A method of forming a bus electrode of a plasma display panel, comprising:
forming a coating on a transparent electrode formed on a substrate, wherein the coating comprises both a black pigment and a conductive material intermixed.

23. A method manufacturing a plasma display panel, comprising:
providing a transparent electrode on a substrate;
forming a bus electrode by coating a bus electrode forming composition on the transparent electrode, followed by exposure, development, and firing; and
providing a dielectric layer to cover the bus electrode,
wherein the bus electrode forming composition comprises a black pigment, a conductive material, an organic binder, a photopolymerization initiator, and a cross-linking agent, and
the black pigment is present in an amount of 25 to 50 parts by weight based on 100 parts by weight of the conductive material.

24. A plasma display panel comprising a bus electrode, wherein the bus electrode comprises an integrated layer that includes both a black pigment and a conductive material.

25. The plasma display panel of claim 24, wherein the black pigment is present in an amount of 25 to 50 parts by weight based on 100 parts by weight of the conductive material.
